(19) United States
(12) Patent Application Publication
(10) Pub. No.: US 2013/0241098 A1
(43) Pub. Date: Sep. 19, 2013

(54) POLYURETHANE SEALING FOAM COMPOSITIONS PLASTICIZED WITH FATTY ACID ESTERS

(71) Applicants: Qavi Anjum, Rochester Hills, MI (US); Adam L. Grzesiak, Midland, MI (US); Lena T. Nguyen, Lake Orion, MI (US); Allen James, Oxford, MI (US); Phillip Filiccia, Grand Blanc, MI (US); Bharat Indu Chaudhary, Princeton, NJ (US); Ali J. El-Khatib, Dearborn, MI (US)

(72) Inventors: Qavi Anjum, Rochester Hills, MI (US); Adam L. Grzesiak, Midland, MI (US); Lena T. Nguyen, Lake Orion, MI (US); Allen James, Oxford, MI (US); Phillip Filiccia, Grand Blanc, MI (US); Bharat Indu Chaudhary, Princeton, NJ (US); Ali J. El-Khatib, Dearborn, MI (US)

(21) Appl. No.: 13/806,123

(22) PCT Filed: Jul. 5, 2011
(86) PCT No.: PCT/US11/42956

§ 371 Date: May 28, 2013

Related U.S. Application Data
(60) Provisional application No. 61/362,545, filed on Jul. 8, 2010.
(60) Provisional application No. 61/436,809, filed on Jan. 27, 2011.

(51) Int. Cl. E04B 1/78; C08G 18/48; C08J 9/12

(52) U.S. Cl. CPC E04B 1/78; C08J 9/125; C08G 18/4825
USPC 264/46.6; 521/174; 524/315; 252/62

(57) ABSTRACT

Plasticized polyisocyanate compositions contain (a) an isocyanate terminated reaction product of a polymeric MDI with a difunctional poly(propylene oxide) homopolymer or difunctional copolymer of at least 85% by weight propylene oxide and up to 15% by weight ethylene oxide, which homopolymer or copolymer has a molecular weight of from about 400 to 2200 and (b) at least one alkyl ester of one or more fatty acids, the polyisocyanate composition having an isocyanate content of from about 8 to about 14% by weight and a Brookfield viscosity of no greater than 5000 cps at 25° C. The plasticized prepolymers are particularly useful in foam formulations for insulating cavities in automotive parts and thermal insulating panels such as the walls of buildings or appliances.

This application claims priority from U.S. Provisional Application No. 61/362,545, filed 8 Jul. 2010 and U.S. Provisional Application No. 61/436,809, filed 27 Jan. 2011.

This invention relates to polyurethane sealing and/or insulating foam compositions, particularly polyurethane foams that are useful for sealing cavities in vehicle parts.

Polyurethane foams have been used in the auto and other industries for a number of purposes, including various cavity-filling applications. For example, foams are often inserted into hollow vehicle parts to dampen sound and vibration and to seal the parts to prevent infiltration by water and other fluids. These foams are typically formed by applying a reactive foam formulation to a part and allowing the formulation to foam in place within the part cavity. The part is often already assembled onto a vehicle when the foam is applied. This means that the foam formulation must be easy to mix and dispense, must cure rapidly before it runs off the part, and preferably initiates curing at moderate temperatures.

Foaming systems are described, for example, in U.S. Pat. Nos. 5,817,860, 6,541,534 and 6,423,755, WO 02/079340A1, WO 03/037948A1 and WO 2007/040617.

Other cavity-filling applications include, for example, the production of a foam insulating layer in a thermal insulating panel (as, for example, appliance wall insulation and/or building wall insulation).

A commercially available foaming system for these applications is a two-part polyurethane composition that includes a polyisocyanate side that contains an isocyanate-terminated prepolymer and a dialkyl phthalate plasticizer, and a curative side that contains a blowing agent. The use of the prepolymer can reduce the number of components that must be mixed at the point of application, and thus can simplify processing. It also reduces the amount of low molecular weight, volatile organic materials in the formulation, which is often important in industrial settings to reduce worker exposure and/or avoid operating costly abatement measures. The prepolymer also has a higher viscosity than its constituent materials, which can help to prevent the foaming system from running off the part before it can cure. In some cases, the plasticized prepolymer is formulated to provide for reasonable mixing ratios when the two parts of the polyurethane composition are mixed and reacted. High mix ratios are often needed when monomeric polyisocyanates are used as the polyisocyanate side, which can complicate metering and mixing. The use of a prepolymer brings the equivalent weight of the polyisocyanate side more into line with that of the polyol side, and thus helps to equilibrate mix ratios.

However, the viscosity of the isocyanate-terminated prepolymer is often too high for the system to be processed easily. The plasticizer functions to alleviate this problem.

Phthalate-based plasticizers are under regulatory pressure and are becoming increasingly expensive, so they are being partially or fully replaced in many applications. A replacement plasticizer must be inexpensive and must be effective in reducing the viscosity of the polyisocyanate side at reasonable use levels. It must exhibit good compatibility with the prepolymer and in the final foam formulation, at the concentration at which it is present. The plasticizer also must not unduly interfere with the expansion and cure of the polyurethane composition.

In one aspect, this invention is a method for sealing or insulating a vehicle member or a thermal insulating panel, comprising mixing a polyisocyanate component with a curative component and at least one catalyst for the reaction of a water or a polyol with a polyisocyanate, dispensing the resulting mixture into a cavity of the vehicle member or thermal insulating panel and subjecting the mixture to conditions sufficient to cause it to cure to form a rigid or semi-rigid foam having a bulk density of 0.5 to 5 pounds per cubic foot (20-80 kg/m³) that at least partially fills the cavity, wherein
(a) the polyisocyanate component includes a mixture of an isocyanate-terminated prepolymer and at least one alkyl ester of one or more fatty acids, has an isocyanate content of from about 8 to about 14% by weight and has a Brookfield viscosity of no greater than 5000 cps at 25° C.;
(b) the curative component contains isocyanate-reactive materials that have an average functionality of at least about 1.8, wherein the isocyanate-reactive materials include water, at least one polyol, or both water and at least one polyol and
(c) if the curative component does not contain water, the reaction mixture contains at least one other blowing agent.

In another aspect, the reaction mixture described herein above further comprises one or more hydrophobicity inducing surfactant, preferably one which provided the cured foam with a 24 hour water absorption of 20 percent or less.

In another aspect, this invention is a polyisocyanate composition comprising (a) an isocyanate-terminated reaction product of a polymeric MDI with a difunctional poly(propylene oxide) homopolymer or difunctional copolymer of at least 85% by weight propylene oxide and up to 15% by weight ethylene oxide, wherein the difunctional homopolymer or difunctional copolymer has a molecular weight of from about 400 to 2200 and (b) at least one alkyl ester of one or more fatty acids, the polyisocyanate composition has an isocyanate content of from about 8 to about 14% by weight and the polyisocyanate composition has a Brookfield viscosity of no greater than 5000 cps at 25° C.

In another aspect, this invention is the polyisocyanate composition described herein above further comprising one or more hydrophobicity inducing surfactants.

The fatty acid ester is surprisingly effective at reducing the viscosity of the polyisocyanate component. At equivalent loadings, the fatty acid ester provides a significantly lower viscosity to the polyisocyanate component than do dialkyl phthalate plasticizers. In addition, the fatty acid ester is highly compatible with the cured polyurethane foam and does not have any significant adverse effect on the curing of the reaction mixture.

The reaction mixture includes a polyisocyanate component and curative component as described below. If the curative component does not contain water, the reaction mixture will further include at least one blowing agent.

The polyisocyanate component includes an isocyanate-terminated prepolymer. The prepolymer is the reaction product of an excess of at least one organic polyisocyanate with at least one polyol. One or more monols can also be used to prepare the prepolymer, in addition to the polyol(s). Prior to dilution with the plasticizer, the prepolymer has an isocyanate content in the range of about 10 to about 23% by weight, and preferably from about 14 to about 21% by weight.

The organic polyisocyanate used to make the prepolymer may be aromatic, aliphatic or cycloaliphatic, although the aromatic types are preferred. Exemplary polyisocyanate compounds include, for example, m-phenylene diisocyanate, 2,4- and/or 2,6-toluene diisocyanate (TDI), the various isomers of diphenylmethanediisocyanate (MDI), the so-called polymeric MDI products (which are a mixture of polymethylene polyphenylene isocyanates in monomeric MDI), carbodiimide-modified MDI products (such as the so-called “liquid MDI” products which have an isocyanate equivalent weight in the range of 135-170), hexamethylene-1,6-diisocyanate, tetramethylene-1,4-diisocyanate, cyclohexane-1,4-diisocyanate, hexahydrotoluene diisocyanate, hydrogenated MDI (H₁₂MDI), naphthylene-1,5-diisocyanate, methoxyphenyl-2,4-diisocyanate, 4,4′-biphenylene diisocyanate, 3,3′-dimethyoxy-4,4′-biphenyl diisocyanate, 3,3′-dimethyldiphenyl methane-4,4′-diisocyanate, 4,4′,4″-triphenylmethane diisocyanate, hydrogenated polymethylene polyphenylisocyanates, toluene-2,4,6-triisocyanate and 4,4′-dimethyldiphenylmethane-2,2′,5,5′-tetraisocyanate. Polymeric MDI products are preferred, especially those which have a free MDI content of from about 22 to about 30% by weight and have an average functionality (number of isocyanate groups per molecule) of about 2.2 to 3.2, more preferably about 2.3 to about 2.8. Such polymeric MDI products are available from The Dow Chemical Company under the trade name PAPI®.

The polyol used to make the prepolymer includes at least one material having at least two hydroxyl groups per molecule and an equivalent weight per hydroxyl group of at least 200. The equivalent weight per hydroxyl group may be as much as 2000. A preferred range is from about 400 to 1500. A preferred functionality for this material is from two to three hydroxyl groups per molecule. A mixture of two or more such materials can be used. Polyethers, including poly(propylene oxide) homopolymers and block and/or random copolymers of propylene oxide and up to 30% by weight ethylene oxide can be used. Polyester polyols are also useful, as are various polyols that are based on vegetable oils. These include, for example, castor oil; transesterified “blown” vegetable oils US Published Patent Applications 2002/0121328, 2002/0119321 and 2002/0090488; polyols are prepared in the reaction of a vegetable oil with an alkanolamine (such as triethanolamine) to form a mixture of monoglycerides, diglycerides and reaction products of the alkanolamine and fatty acids from the vegetable oil, as described in GB 1,248,919; amides of hydroxymethylated fatty acids with alkanolamines, such as are described in Khoe et al., “Polyurethane Foams from Hydroxymethylated Fatty Diethanolamides”, J. Amer. Oil Chemists' Society 50:331-333 (1973); and hydroxymethyl-containing polyester polyol (HMPP)s which are derived from a fatty acid, as described in WO 04/096744.

It is also possible to include in the polyol mixture a small amount of a chain extender, by which it is meant a material having exactly two hydroxyl groups per molecule and a hydroxyl equivalent weight of 199 or less.

A preferred prepolymer is an isocyanate-terminated reaction product of a polymeric MDI with a difunctional poly(propylene oxide) homopolymer or a difunctional copolymer of at least 85% by weight propylene oxide and up to 15% by weight ethylene oxide. The homopolymer or copolymer has a molecular weight of from about 400 to 2200. The homopolymer or copolymer may be used as a blend with a monol such as a lower alkanol, hydroxyethyl acrylate, hydroxyethyl methacrylate, and the like. This preferred prepolymer has an isocyanate content of from 14 to 21% by weight, prior to dilution with the plasticizer. The isocyanate functionality of the prepolymer (exclusive of non-reactive materials such as plasticizers, surfactants and the like) is advantageously at least about 2.0, preferably at least 2.2, to about 3.5, preferably to about 3.2, more preferably to about 3.0, isocyanate groups/molecule on average.

The polyisocyanate component contains a plasticizer that includes at least one alkyl ester of one or more fatty acids. The alkyl group is preferably a C₁-C₄ alkyl group.

The fatty acid ester plasticizer is an alkyl ester of one or more linear monocarboxylic acids that contains (including the carbonyl carbon of the carboxylic acid group) from 12 to 30 carbon atoms. The alkyl group is preferably methyl, ethyl, n-propyl, isopropyl, n-butyl, sec-butyl, isobutyl or t-butyl. Methyl esters are more preferred on the basis of their easy synthesis and availability. The linear monocarboxylic acid(s) preferably contain from 12 to 24 carbon atoms and more preferably from 12 to 20 carbon atoms. The linear monocarboxylic acid(s) may contain one or more sites of carbon-carbon unsaturation, or may be saturated. The linear monocarboxylic acid(s) may contain substituent groups such as hydroxyl, halogen, nitro and the like.

The linear carboxylic acids may be a mixture of the constituent fatty acids of one or more vegetable oils or animal fats. Suitable such fatty acids include (but are not limited to) the constituent fatty acids of canola oil, castor oil, citrus seed oil, cocoa butter, coconut oil, corn oil, cottonseed oil, hemp oil, lard, linseed oil, oat oil, olive oil, palm oil, palm kernel oil, peanut oil, rapeseed oil, rice bran oil, safflower oil, sesame oil, soybean oil, sunflower oil or lard. The constituent fatty acids of most vegetable oils and animal fats are mixtures of two or more linear monocarboxylic acids that may differ in chain length, substituents and/or the number of unsaturation sites. The content of such a fatty acid mixture obtained in any particular case will depend on the particular plant or animal species that is the source of the oil or fat, and to a lesser extent may depend on the geographical source of the oil as well as the time of year in which the oil has been produced and other growing conditions. Fatty acids are conveniently obtained from a starting vegetable oil by a hydrolysis reaction, which produces the fatty acids and glycerine.

A fatty acid mixture obtained from a vegetable oil may be purified to isolate one or more of the constituent fatty acids, if a more defined material is desired.

An alkyl ester of a fatty acid or fatty acid mixture can be prepared from a fatty acid by reaction of the fatty acid or mixture with the corresponding alcohol. Alternatively, a fatty acid ester plasticizer can be obtained directly by reaction of the oil with the corresponding alcohol.

Preferred fatty acid ester plasticizers have melting temperatures of 10° C. or lower. A preferred fatty acid ester plasticizer is an alkyl ester of a mixture of the constituent fatty acids of soy oil.

Commercially available soy methyl ester products that are useful are available from Bunge North America and Ag Processing Inc.

The quantity of the plasticizer is such that the formulated polyisocyanate composition has an isocyanate content of from about 8 to about 14% by weight and a Brookfield viscosity of no greater than 5000 cps at 25° C. The Brookfield viscosity of the formulated polyisocyanate component is preferably no greater than 2000 cps at 25° C.

It is possible to use a mixture of two or more types of plasticizer. The mixture contains at least one alkyl fatty acid ester plasticizer as described before, and at least one other plasticizer. The other plasticizer may include materials such as vegetable oils as well as synthetic plasticizers such as (but not limited to) the dialkyl phthalate plasticizers, trimellitate ester plasticizers and adipate ester plasticizers. The other plasticizer preferably constitutes less than 95%, more preferably less than 75%, and still more preferably 50% or less by weight of such a plasticizer mixture.

It is preferred that the polyisocyanate component contains less than 25%, more preferably less than about 15%, especially 5% by weight or less of isocyanate-containing compounds having a molecular weight of 300 or less. Having such a low monomeric isocyanate content substantially reduces the risks of polyisocyanate inhalation exposure, so costly engineering controls such as downdraft ventilation can be substantially reduced or potentially eliminated.

The prepolymer may be prepared in the presence of a surfactant, or blended with a surfactant, including surfactants of the type described in U.S. Pat. No. 4,390,645, incorporated by reference. The surfactant is typically used if desired to facilitate compatibility of the other components used in making the prepolymer. In addition, the surfactant may play a beneficial role in forming a foam from the prepolymer. The function and use of surfactants in polyurethane foams is well known in the art and has been described. See, for example, Herrington, Nafziger, Hock and Moore in Flexible Urethane Foams, pp. 2.22-2.25. Surfactants employed in the preparation of polyurethane foams are generally polysiloxanes/polyalkylene oxide copolymers, and are available from several manufacturers including, for example, Goldschmidt Chemical Corp., OSi, and Air Products and Chemicals, Inc. Almost all polyurethane foams are made with the aid of nonionic silicone-based surfactants.

Surfactants help to control the precise timing and the degree of cell-opening. Within each foam formulation a minimum level of surfactant is needed to produce commercially acceptable foam. In the absence of a surfactant, a foaming system will normally experience catastrophic coalescence and exhibit an event known as boiling. With the addition of a small amount of surfactant, stable yet imperfect foams can be produced; and, with increasing surfactant concentration, a foam system will show improved stability and cell-size control. At optimum concentrations, stable open-cell foams are produced. However, at higher surfactant levels the cell-windows become overstabilized and the resulting foams are tighter and have less desirable physical properties. Surfactants that may be used to produce foams with a particular polyisocyanate/polyol composition are referred to as foam-stabilizing surfactants.

Examples of surfactants include nonionic surfactants and wetting agents, such as those prepared by the sequential addition of propylene oxide and then ethylene oxide to propylene glycol, solid or liquid organosilicones, polyethylene glycol ethers of long chain alcohols, tertiary amine or alkylolamine salts of long chain alkyl acid sulfate esters, alkyl sulfonic esters and alkyl arylsulfonic acids. The surfactants prepared by the sequential addition of propylene oxide and then ethylene oxide to propylene glycol are preferred, as are the solid or liquid organosilicones.

The polyoxyalkylene (or polyol) end of the surfactant is responsible for the emulsification effect. The silicone end of the molecule lowers the bulk surface tension. When a hydrolyzable surfactant, which contains Si—O linkages between the silicon and polyether groups, is contacted with water (as in a foam masterbatch or a silicone/amine/water stream) the molecule breaks apart to form siloxane and glycol molecules. When this occurs, the individual molecules no longer exhibit the proper surfactant effects. Non-hydrolyzable type surfactants, which contain a water stable Si—C bond between the silicon and polyether chain, are thus preferred.

Commercial foams are generally manufactured using “forgiving” surfactants that function over a range of concentrations for a given polyisocyanate/polyol combination, although there will be an optimal concentration. These surfactants are useful because foams produced from them are not affected by minor fluctuations in the manufacturing process such as variations in metering caused by machine differences. Thus, in the manufacture of a conventional foam, once a suitable “forgiving” catalyst and concentration are identified, there is no motivation to vary the identity or concentration of the surfactant.

Examples of suitable organosilicones include those sold by Evonik under the Tegostab™ name, including, for example, Tegostab B8443, Tegostab B8476, Tegostab B8485, Tegostab B8486, and Tegostab B8490. When a surfactant is used, it is typically present in an amount of about 0.0015 to about 1 percent by weight of the prepolymer component.

All foam stabilizing surfactants which result in a hydrophobic polyurethane foam are referred to herein as “hydrophobicity inducing surfactants.” Hydrophobicity inducing surfactants are well known, for example, see U.S. Pat. No. 4,264,743 which is incorporated herein in its entirety. In one embodiment of the present invention, suitable surfactants are foam stabilizing surfactants that produce a hydrophobic foam when the graft polyol and conventional polyol react with the polyisocyanate in the presence of the surfactant. For a given composition, there may be several suitable hydrophobicity inducing surfactants and other surfactants may not be suitable. The hydrophobicity inducing surfactants are generally not “forgiving” in the manufacture of conventional foams. Furthermore, surfactants useful for the purposes of the present invention include surfactants that are not typically recommended for conventional flexible foams, including high graft polyol foams of the present invention. Surfactants already identified as hydrophobicity inducing surfactants suitable for the invention include: B8110, B8229, B8232, B8240, B8870, B8418, and B8462 from Goldschmidt Chemical Corp.; L626, L600 and L6164 from OSi; DC5604 and DC5598 from Air Products and Chemicals, Inc., and DC-198 from Dow Corning. Preferred surfactants result in foams capable of resisting the penetration of water for more than 24 hours, for example, B8870, B8110, B8240, B8418, B8462, L626, L6164, DC5604, DC5598, and DC-198.

Hydrophobicity inducing surfactants include a broad range of surfactants that may be recommended for use in forming flexible foam, in forming semi-rigid foam and in forming rigid foam. The surfactants identified above represent a cross section of commercially available surfactants with differing manufacturers' recommendations for use. Said surfactants may be used alone or in combination with one or more hydrophobicity inducing surfactants to achieve the desired level of reduction of water absorption. Once a suitable composition has been identified in accordance with the present invention, other hydrophobicity inducing surfactants may be identified by preparing sample batches of foam followed by hydrophobicity testing. Such optimization is within the knowledge of a person skilled in the art of foam manufacturing.

In one embodiment of the present invention, the method of the present invention provides a cured foam with a water absorption after 24 hours equal to or less than 20 percent, preferably equal to or less than 15 percent, more preferably equal to or less than 10 percent, and even more preferably equal to or less than 5 percent. In one embodiment of the present invention, the method of the present invention provides a cured foam with a 24 hour water absorption equal to or greater than 0 percent, preferably equal to or greater than 1 percent, and more preferably equal to or greater than 2 percent.

Water absorption is determined for the foams produced in accordance with the method of the present invention by placing a weighed foam in a humidity chamber, operating at 38° C. and 100 percent relative humidity, for a period of ten days. The foams are then removed from the humidity chamber and allowed to stand for 24 hours at ambient conditions. The foam sample is then weighed. The amount of water weight absorbed and the percentage of absorbed water is determined by comparing the weight of the treated foam with its initial weight.

The polyisocyanate component is reacted with a curative component to form the foam. The curative component includes water, a polyol or mixture of polyols, or both water and at least one polyol. In cases in which the curative component includes a polyol, it will most typically include a blend of two or more different polyols.

The functionality (average number of isocyanate-reactive groups/molecule) of the curative component (including polyols (if present), water (if present) and amine-functional compounds as described below, but exclusive of non-isocyanate reactive materials (if present)) is at least about 1.8. It may be at least 2.0, at least 2.3 or at least 2.5. Water, for purposes of this invention, is considered to have a functionality of 2.

In some embodiments, the curative component contains water, but no other isocyanate-reactive materials. In such cases, at least one catalyst is typically included in the curative component. Auxiliaries such as thickening agents, biocides, and the like may be present, but these are typically present in small quantities.

Suitable polyols are compounds having at least two isocyanate-reactive hydroxyl groups per molecule, provided that the curative component has an average functionality of at least about 1.8, as explained before. When the curative contains one or more polyol compounds, the average functionality may be at least 2.0, at least 2.3 or at least about 2.5, to about 6.0, preferably to about 4.0. The functionality of the individual polyols preferably ranges from about 2 to about 12, more preferably from about 2 to about 8. The hydroxyl equivalent weight of the individual polyols may range from about 31 to about 3000 or more. Preferably, the hydroxyl equivalent weight of the individual polyols is from about 31 to about 500, more preferably from about 31 to about 250, even more preferably from about 31 to about 200.

Suitable polyols include compounds such as alkylene glycols (e.g., ethylene glycol, propylene glycol, 1,4-butane diol, 1,6-hexanediol and the like), glycol ethers (such as diethylene glycol, triethylene glycol, dipropylene glycol, tripropylene glycol and the like), glycerine, trimethylolpropane, pentaerythritol, tertiary amine-containing polyols such as triethanolamine, triisopropanolamine, ethylene oxide and/or propylene oxide adducts of amine compounds as described below, and the like, polyether polyols, polyester polyols, and the like. Among the suitable polyether polyols are polymers of alkylene oxides such as ethylene oxide, propylene oxide and 1,2-butylene oxide or mixtures of such alkylene oxides. Preferred polyethers are polypropylene oxides or polymers of a mixture of propylene oxide and a small amount (up to about 15 weight percent) ethylene oxide. These preferred polyethers can be capped with up to about 30% by weight ethylene oxide.

Polyester polyols are also suitable. These polyester polyols include reaction products of polyols, preferably diols, with polycarboxylic acids or their anhydrides, preferably dicarboxylic acids or dicarboxylic acid anhydrides. The polycarboxylic acids or anhydrides may be aliphatic, cycloaliphatic, aromatic and/or heterocyclic and may be substituted, such as with halogen atoms. The polycarboxylic acids may be unsaturated. Examples of these polycarboxylic acids include succinic acid, adipic acid, terephthalic acid, isophthalic acid, trimellitic anhydride, phthalic anhydride, maleic acid, maleic acid anhydride and fumaric acid. The polyols used in making the polyester polyols preferably have an equivalent weight of about 150 or less and include ethylene glycol, 1,2- and 1,3-propylene glycol, 1,4- and 2,3-butane diol, 1,6-hexane diol, 1,8-octane diol, neopentyl glycol, cyclohexane dimethanol, 2-methyl-1,3-propane diol, glycerine, trimethylol propane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and the like. Polycaprolactone polyols are also useful.

One or more of the polyols may contain dispersed polymer particles. These materials are commercially known and are commonly referred to as “polymer polyols” (or, sometimes “copolymer polyols”). The dispersed polymer particles may be, for example, polymers of a vinyl monomer (such as styrene, acrylonitrile or styrene-acrylonitrile particles), polyurea particles or polyurethane particles. Polymer or copolymer polyols containing from about 2 to about 50% or more by weight dispersed polymer particles are suitable. When used, this polymer or copolymer polyol may constitute up to about 45%, preferably from about 5 to about 40%, of the weight of all isocyanate-reactive materials in the curative component.

The curative component may include a tertiary amine-containing polyol and/or an amine-functional compound. The presence of these materials tends to increase the reactivity of the curative component during the early stages of its reaction with the polyisocyanate component. This in turn helps the reaction mixture to build viscosity more quickly when first mixed and applied without unduly decreasing cream time, and thus reduces run-off or leakage. Such tertiary amine-containing polyols include, for example, triisopropanol amine, triethanolamine and ethylene and/or propylene oxide adducts of ethylene diamine, toluene diamine or aminoethylpiperazine having a molecular weight of up to about 800, preferably up to about 400. Also of interest are the so-called “Mannich” polyols, which are the alkoxylated reaction products of a phenolic compound, formaldehyde and a secondary amine. The amine-functional compound is a compound having at least two isocyanate-reactive groups, of which at least one is a primary or secondary amine group. Among these are monoethanolamine, diethanolamine, monoisopropanol amine, diisopropanol amine and the like, and aliphatic polyamines such as aminoethylpiperazine, diethylene triamine, triethylene tetraamine and tetraethylenepentaamine. Also included among these compounds are the so-called aminated polyethers in which all or a portion of the hydroxyl groups of a polyether polyol are converted to primary or secondary amine groups.

The polyisocyanate and curative components are reacted in the presence of at least one blowing agent. In the typical case, the curative component will include or consist of water, which functions as a blowing agent. If the curative component does not contain water, then some other blowing agent is present. This other blowing agent can be formulated into the polyisocyanate component, if it is not reactive towards isocyanate groups, or into the curative component. It can also be provided separately. A wide variety of blowing agents can be used, including various hydrocarbons, various hydrofluorocarbons, a variety of chemical blowing agents that produce nitrogen or carbon dioxide under the conditions of the foaming reaction, and the like. When a very highly reactive system is desired, a preferred blowing agent includes a carbamate of an amine that contains at least one hydroxyl group. The amine preferably also contains at least one, preferably one or two, ether groups per molecule. Suitable carbamates are conveniently prepared by reacting an alkanolamine with carbon dioxide, as described, for example, in U.S. Pat. Nos. 4,735,970, 5,464,880, 5,587,117 and 5,859,285, all incorporated herein by reference. Especially preferred alkanolamines have the structure

H_{z}N—[(CHR′—CHR″—O—)ₐ—(CH₂)ₓ—OH]_{y} (II)

where y is at least one, z+y equals 3, R′ and R″ are independently hydrogen, ethyl or methyl, x is a number from 1 to 4, and a is 1 or 2, provided that a times y is not greater than 2. Especially preferred alkanolamines of this type are 2-(2-aminoethoxy)ethanol and 2(2-(2-aminoethoxyl)ethoxy)ethanol.

It is possible to use a blowing agent in addition to water, in those cases in which the curative component contains water. Water may be the sole blowing agent.

Enough of the blowing agent is used to provide a foam density in the range of about 0.5 to about 5 pounds/cubic foot (20-80 kg/m³). Preferred foam densities are about 1.2 to about 3 pounds/cubic foot (19-48 kg/m³).

A catalyst for the reaction of water or a polyol with an isocyanate will in most cases be used in the method of the invention. Most typically, this catalyst will be incorporated into the curative component, but in some cases can be mixed into the polyisocyanate component or added as a separate stream.

Suitable catalysts include those described by U.S. Pat. No. 4,390,645, incorporated herein by reference. Representative catalysts include:

(a) tertiary amines, such as trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, bis(2-dimethylaminoethyl)ether, morpholine,4,4′-(oxydi-2,1-ethanediyl)bis and triethylenediamine;
(b) tertiary phosphines, such as trialkylphosphines and dialkylbenzylphosphines;
(c) chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni;
(d) acidic metal salts of strong acids, such as ferric chloride, stannic chloride, stannous chloride, antimony trichloride, bismuth nitrate and bismuth chloride;
(e) strong bases, such as alkali and alkaline earth metal hydroxides, alkoxides and phenoxides;
(f) alcoholates and phenolates of various metals, such as Ti(OR)₄, Sn(OR)₄ and Al(OR)₃, wherein R is alkyl or aryl, and the reaction products of the alcoholates with carboxylic acids, beta-diketones and 2-(N,N-dialkylamino)alcohols;
(g) salts of organic acids with a variety of metals, such as alkali metals, alkaline earth metals, Al, Sn, Pb, Mn, Co, Ni and Cu including, for example, sodium acetate, stannous octoate, stannous oleate, lead octoate, metallic driers, such as manganese and cobalt naphthenate; and
(h) organometallic derivatives of tetravalent tin, trivalent and pentavalent As, Sb and Bi and metal carbonyls of iron and cobalt.

Tertiary amine catalysts are preferred, and especially preferred are the so-called “reactive” amine catalysts that contain a hydroxyl or primary or secondary amine group that can react with an isocyanate to become chemically bonded into the foam. Among these especially preferred catalysts are N,N,N-trimethyl-N-hydroxyethyl-bis(aminoethyl)ether (available from Huntsman Chemical under the trade name ZF-10) and N,N-dimethyl 2-aminoethoxyethanol (available from Nitrol-Europe under the trade name NP-70), and those sold by Air Products under the trade names Dabco™ 8154 and Dabco™ T. These reactive catalysts are included in the calculation of the average functionality of the curative component.

Catalysts that strongly promote the formation of isocyanurate groups in the foam are less desired and preferably absent.

The amount of catalyst needed will depend somewhat on the particular catalyst and the nature of the other components in the formulation. For example, the total amount of catalyst used may be about 0.0015 to about 5, preferably from about 0.01 to about 1 percent by weight.

In addition, the curative component and/or the prepolymer component can contain various auxiliary components as may be useful in making a rigid foam, such as surfactants, fillers, colorants, odor masks, flame retardants, biocides, antioxidants, UV stabilizers, antistatic agents, thixotropic agents and cell openers.

Suitable surfactants include commercially available polysiloxane/polyether copolymers such as Tegostab (trademark of Evonik) B-8462, B-8443, B-8870, and B-8404, and DC-198 and DC-5043 surfactants, available from Dow Corning.

Examples of suitable flame retardants include phosphorous compounds, halogen-containing compounds and melamine.

Examples of fillers and pigments include calcium carbonate, titanium dioxide, iron oxide, chromium oxide, azo/diazo dyes, phthalocyanines, dioxazines and carbon black.

Examples of UV stabilizers include hydroxybenzotriazoles, zinc dibutyl thiocarbamate, 2,6-ditertiarybutyl catechol, hydroxybenzophenones, hindered amines and phosphites.

Examples of cell openers include silicon-based antifoamers, waxes, finely divided solids, liquid perfluorocarbons, paraffin oils and long chain fatty acids.

The foregoing additives are generally used in small amounts, such as from about 0.01 percent to about 1 percent by weight of the polyisocyanate component.

Foam according to the invention is prepared by mixing the curative and polyisocyanate components in the presence of the catalyst and blowing agent, dispensing the resulting mixture into the cavity of a vehicle member or a thermal insulating panel and allowing the reaction mixture to react within the cavity and form a foam within the cavity. The cavity is preferably open, by which it is meant that the portion of the substrate into which the reaction mixture is dispensed is open to the atmosphere as the foam reacts, expands and cures. The “cavity” may be a hollow space within the part, or other suitable shape. The cavity may be one that is incapable of retaining a fluid due to its shape or orientation.

Examples of cavity-containing vehicle members include pillars, rockers, sills, sails, cowls, plenum, seams, frame rails, vehicle sub assemblies, hydro-formed parts, cross car beams and engine cradles. These may be assembled onto a vehicle or vehicle frame when the foam formulation is applied and foamed.

Examples of thermal insulating panels include the interior and/or exterior walls of a building, or a section of such a wall; the walls of an appliance such as a freezer, refrigerator, cooler, oven, thermos or other insulated decanter and the like.

The ratios of the polyisocyanate and curative components are advantageously selected so as to provide an isocyanate index (ratio of NCO to isocyanate-reactive groups) of about 0.7, preferably about 0.85, more preferably about 0.95, to about 1.5, preferably to about 1.35, more preferably to about 1.25. The curative component and the isocyanate component may be formulated so that these isocyanate indices are produced when those components are in a volume ratio of from 5:1 to 1:5, from 4:1 to 1:4, from about 2:1 to 1:2, or from about 1.5:1 to 1:1.5. Equivalent weights of the curative and isocyanate components are therefore established so that the isocyanate index and volume ratios are concurrently met. When the curative component contains mostly water, the mixing ratio may be as high as 30:1.

The components may be at ambient temperature or at a slightly elevated temperature (from 30 to 80° C., for example) at the time they are mixed together and dispensed. It is usually unnecessary to apply heat to the vehicle member or thermal insulation panel to drive the expansion and curing reactions, but it is within the scope of the invention to do so. Upon expansion and curing, the foam formulation produces a foam that has a density of from 1.25 to 5 pounds/cubic foot (20 to 80 kg/m³), which at least partially fills the cavity. It should expand to fill the entire cross-sectional area of the cavity, for at least a portion of its length. In some applications, such as vehicle cavity sealing and building wall insulations, the resulting foam acts as a barrier to the infiltration of water and other fluids through the cavity, and also dampens noise and vibration through the filled structure.

The following examples are provided to illustrate the invention, but are not intended to limit the scope thereof. All parts and percentages are by weight unless otherwise indicated.

### EXAMPLES 1-6 AND COMPARATIVE SAMPLES A, B AND C

An isocyanate-terminated prepolymer is prepared by mixing 24.36 parts of a 1000 equivalent weight poly(propylene oxide)diol, 2.33 parts of butanol, 40.56 parts of a polymeric MDI having an isocyanate functionality of 3.2 and an isocyanate equivalent weight of 138, 0.35 parts of an organosilicone surfactant and 32.4 parts of soy methyl esters (from Bunge North America). This mixture is heated under nitrogen and with stirring at 70° C. to a constant isocyanate concentration to form a plasticized prepolymer composition. This product has an isocyanate content of 10% by weight; the isocyanate content of the prepolymer by itself is approximately 14.9% by weight. This product is designated as Example 1.

Examples 2-6 and Comparative Samples A, B and C are prepared in like manner, except that the amounts and types of the components are changed as indicated in Table 1.

TABLE 1

| | Parts by weight | | | | | | | |
|---|---|---|---|---|---|---|---|---|
| Component | Ex. 2 | Ex. 3 | Ex. 4 | Ex. 5 | Ex. 6 | Comp. A* | Comp. B* | Comp. C* |
| Polyol | 16.04 | 9.82 | 24.36 | 16.04 | 9.82 | 24.36 | 16.04 | 9.82 |
| Butanol | 2.25 | 2.20 | 2.33 | 2.25 | 2.20 | 2.33 | 2.25 | 2.20 |
| Polymeric MDI | 39.27 | 38.31 | 40.56 | 39.27 | 38.31 | 40.56 | 39.27 | 38.31 |
| Surfactant | 0.35 | 0.35 | 0.35 | 0.35 | 0.35 | 0.35 | 0.35 | 0.35 |
| Plasticizer, type | 42.06, A | 49.32, A | 32.40, B | 42.06, B | 49.32, B | 32.40, C | 42.06, C | 49.32, C |
| Formulation % NCO | 10 | 10 | 10 | 10 | 10 | 10 | 10 | 10 |
| Prepolymer, % NCO | 17.4 | 19.9 | 14.9 | 17.4 | 19.9 | 14.9 | 17.4 | 19.9 |

*Not an example of this invention. Plasticizer A is soy methyl ester from Bunge North America. Plasticizer B is Soygold 1000 soy methyl ester from Ag Processing Inc. Plasticizer C is diisononyl phthalate.

Viscosities of each of the foregoing polyisocyanate components are measured at 25° C., on fresh samples and on samples that have been aged at 25° C. under nitrogen for three months. Measurements are made using a Brookfield 2000+H cone and plate viscometer, with a 60 second run time. Results are indicated in Table 2.

TABLE 2

| Example or Comp. | Initial | 3-Month |
|---|---|---|
| Sample No. | Viscosity, cps | Viscosity, cps |
| 1 | 513 | 2828 |
| 2 | 221 | 760 |
| 3 | ND | ND |
| 4 | 380 | 493 |
| 5 | 136 | 162 |
| 6 | 54 | 62 |
| A* | 2313 | 2591 |
| B* | 809 | 1026 |
| C* | 408 | 413 |

As can be seen from the data in Table 2, the fatty acid ester plasticizers are much more effective in reducing the viscosity of the prepolymer composition, than is the phthalate ester plasticizer, at equivalent concentration.

For further comparison, prepolymer compositions are made using soybean oil, palm oil and canola oil as the plasticizers. The vegetable oils in each case phase separates rapidly from the prepolymer.

### EXAMPLES 7-12 AND COMPARATIVE SAMPLES D, E AND F

A series of plasticized polyisocyanates (Ex. 7-12 and Comp. Samples D-F) is made in the same general manner as described with respect to Example 1, except the polyisocyanate in these cases is a 2.7 functional, 134 equivalent weight polymeric MDI. Formulation details are provided in Table 3.

TABLE 3

| Ingredient, pbw | Ex. 7 | Ex. 8 | Ex. 9 | Ex. 10 | Ex. 11 | Ex. 12 | Comp. D* | Comp. E* | Comp. F* |
|---|---|---|---|---|---|---|---|---|---|
| Polyol | 25.39 | 17.03 | 10.78 | 25.39 | 17.03 | 10.78 | 25.39 | 17.03 | 10.78 |
| Butanol | 2.34 | 2.26 | 2.21 | 2.34 | 2.26 | 2.21 | 2.34 | 2.26 | 2.21 |
| Polymeric MDI | 39.53 | 38.28 | 37.34 | 39.53 | 38.28 | 37.34 | 39.53 | 38.28 | 37.34 |
| Surfactant | 0.35 | 0.35 | 0.35 | 0.35 | 0.35 | 0.35 | 0.35 | 0.35 | 0.35 |
| Plasticizer, type | 32.40, A | 42.08, A | 49.32, A | 32.40, B | 42.08, B | 49.32, B | 32.40, C | 42.08, C | 49.32, C |
| Formulation % NCO | 10 | 10 | 10 | 10 | 10 | 10 | 10 | 10 | 10 |
| Prepolymer, % NCO | 14.9 | 17.4 | 19.9 | 14.9 | 17.4 | 19.9 | 14.9 | 17.4 | 19.9 |

*See Table 1.

Viscosities of each of the foregoing polyisocyanate components are measured at 25° C., on fresh samples and on samples that have been aged at 25° C. under nitrogen for three months. Results are indicated in Table 4.

| Example or Comp. | Initial | 3-Month |
|---|---|---|
| Sample No. | Viscosity, cps | Viscosity, cps |
| 7 | 302 | 390 |
| 8 | 88 | 200 |
| 9 | 42 | 53 |
| 10 | 242 | 273 |
| 11 | 80 | 102 |
| 12 | 53 | 127 |
| D* | 1245 | 1301 |
| E* | 481 | 541 |
| F* | 233 | 281 |

As can be seen from the data in Table 4, the fatty acid ester plasticizers are again much more effective in reducing the viscosity of the prepolymer composition than is the phthalate ester plasticizer, at equivalent concentration.

### EXAMPLES 13-18 AND COMPARATIVE SAMPLES G, H AND I

A series of plasticized polyisocyanates (Ex. 13-18 and Comp. Samples G-I) is made in the same general manner as described with respect to Examples 7-12, except the polyol in these cases is a 500 equivalent weight poly(propylene oxide)diol. Formulation details are provided in Table 5.

TABLE 5

| Ingredient, pbw | Ex. 13 | Ex. 14 | Ex. 15 | Ex. 16 | Ex. 17 | Ex.18 | Comp. G* | Comp. H* | Comp. I* |
|---|---|---|---|---|---|---|---|---|---|
| Polyol | 22.40 | 15.03 | 9.51 | 22.40 | 15.03 | 9.51 | 22.40 | 15.03 | 9.51 |
| Butanol | 2.50 | 2.37 | 2.28 | 2.50 | 2.37 | 2.28 | 2.50 | 2.37 | 2.28 |
| Polymeric MDI | 42.34 | 40.17 | 38.54 | 42.34 | 40.17 | 38.54 | 42.34 | 40.17 | 38.54 |
| Surfactant | 0.35 | 0.35 | 0.35 | 0.35 | 0.35 | 0.35 | 0.35 | 0.35 | 0.35 |
| Plasticizer, type | 32.40, A | 42.08, A | 49.32, A | 32.40, B | 42.08, B | 49.32, B | 32.40, C | 42.08, C | 49.32, C |
| Formulation % NCO | 10 | 10 | 10 | 10 | 10 | 10 | 10 | 10 | 10 |
| Prepolymer, % NCO | 14.9 | 17.4 | 19.9 | 14.9 | 17.4 | 19.9 | 14.9 | 17.4 | 19.9 |

*See Table 1.

Viscosities of each of the foregoing polyisocyanate components are measured at 25° C., on fresh samples and on samples that have been aged at 25° C. under nitrogen for three months. Results are indicated in Table 6.

TABLE 6

| Example or Comp. | Initial | 3-Month |
|---|---|---|
| Sample No. | Viscosity, cps | Viscosity, cps |
| 13 | 408 | 486 |
| 14 | 105 | 221 |
| 15 | 44 | 53 |
| 16 | 329 | 388 |
| 17 | 89 | ND |
| 18 | 55 | 133 |
| G* | 2080 | 2145 |
| H* | 606 | 728 |
| I* | 266 | 308 |

As can be seen from the data in Table 6, the fatty acid ester plasticizers are again much more effective in reducing the viscosity of the prepolymer composition than is the phthalate ester plasticizer, at equivalent concentration.

### EXAMPLES 19-24 AND COMPARATIVE SAMPLES J, K AND L

A series of plasticized polyisocyanates (Ex. 19-24 and Comp. Samples J, K and L) is made in the same general manner as described with respect to Examples 7-12, except the polyol in these cases is a 216 equivalent weight poly(propylene oxide)diol. Formulation details are provided in Table 7.

TABLE 7

| Ingredient, pbw | Ex. 19 | Ex. 20 | Ex. 21 | Ex. 22 | Ex. 23 | Ex. 24 | Comp. J* | Comp. K* | Comp. L* |
|---|---|---|---|---|---|---|---|---|---|
| Polyol | 16.94 | 11.37 | 7.20 | 16.94 | 11.37 | 7.20 | 16.94 | 11.37 | 7.20 |
| Butanol | 2.81 | 2.58 | 2.41 | 2.81 | 2.58 | 2.41 | 2.81 | 2.58 | 2.41 |
| Polymeric MDI | 47.50 | 43.62 | 40.73 | 47.50 | 43.62 | 40.73 | 47.50 | 43.62 | 40.73 |
| Surfactant | 0.35 | 0.35 | 0.35 | 0.35 | 0.35 | 0.35 | 0.35 | 0.35 | 0.35 |
| Plasticizer, type | 32.40, A | 42.08, A | 49.32, A | 32.40, B | 42.08, B | 49.32, B | 32.40, C | 42.08, C | 49.32, C |
| Formulation % NCO | 10 | 10 | 10 | 10 | 10 | 10 | 10 | 10 | 10 |
| Prepolymer, % NCO | 14.9 | 17.4 | 19.9 | 14.9 | 17.4 | 19.9 | 14.9 | 17.4 | 19.9 |

*See Table 1.

Viscosities of each of the foregoing polyisocyanate components are measured at 25° C., on fresh samples and on samples that have been aged at 25° C. under nitrogen for three months. Results are indicated in Table 8.

TABLE 8

| Example or Comp. | Initial | 3-Month |
|---|---|---|
| Sample No. | Viscosity, cps | Viscosity, cps |
| 19 | 1225 | 1515 |
| 20 | 177 | 304 |
| 21 | 56 | 71 |
| 22 | 905 | 1059 |
| 23 | 141 | 182 |
| 24 | 70 | 146 |
| J* | 9150 | 9762 |
| K* | 1457 | 1631 |
| L* | 426 | 457 |

As can be seen from the data in Table 6, the fatty acid ester plasticizers are again much more effective in reducing the viscosity of the prepolymer composition, than is the phthalate ester plasticizer, at equivalent concentration.

### Foam Screening Evaluations

Polyurethane foams are made from polyisocyanate component Examples 5, 11, 17 and 23. 2.88 g of the polyisocyanate component is hand mixed with 0.12 g of a mixture containing 64% water, 34.95% of a catalyst, 0.55% of a thickening agent and 0.5% of an odor control agent until creaming is observed, and then allowed to rise freely at ambient temperature. The cured samples are allowed to age for four months with minimum light exposure, and then are examined visually.

The foam sample prepared from polyisocyanate component Example 5 shows some yellowing, which indicates that some separation of the plasticizer has occurred. The foam sample prepared from polyisocyanate component Example 23 also shows some evidence of incompatibility. The foam samples from polyisocyanate component Examples 11 and 17 show little sign of incompatibility and are visually similar to foams made using similar amounts of the phthalate plasticizer.

### EXAMPLE 25

A prepolymer is made in the general manner described in Example 1, from 10.65 parts of a difunctional poly(propylene oxide) homopolymer having an equivalent weight of about 216, 2.55 parts n-butanol, 20 parts of soy methyl esters (Soygold 1000), 20 parts of diisononyl phthalate, 0.8 parts of an organosilicone surfactant and 45 parts of a polymeric MDI. The plasticized prepolymer has a viscosity of 1120 cps at 25° C.

A foam is made from the prepolymer, in the general manner described with regard to the foam screen evaluation above. The foam has a rise time of about seconds, a gel time of 7 seconds and a tack free time of about 8 seconds. Foam density is 1.90 pounds/cubic foot (about 30.4 kg/m³).

### EXAMPLE 26 AND COMPARATIVE SAMPLE M

A prepolymer is made in the general manner described in Example 1, from 9.43 parts of a difunctional poly(propylene oxide) homopolymer having an equivalent weight of about 432, 3.6 parts of a trifunctional EO/PO copolymer having an equivalent weight of about 1652, 3.23 parts n-butanol, 30 parts of soy methyl esters (Soygold 1000), 1 part of one or more organosilicone surfactants and 52.73 parts of a polymeric MDI.

A foam is made from the prepolymer, in the general manner described with regard to the foam screen evaluation above. The foam has a tack free time of about 7 seconds and a foam density is 1.4 pounds/cubic foot (lb/ft³). Compositions and results are indicated in Table 9.

TABLE 9

Parts by weight

| | Ex. 26 | Comp. M* |
|---|---|---|
| COMPONENT | | |
| Di-functional Polyol | 9.43 | 9.43 |
| Tri-functional Polyol | 3.6 | 3.6 |
| Butanol | 3.23 | 3.23 |
| Polymeric MDI | 52.73 | 52.73 |
| Surfactant, type | 1, E | 1, F |
| Plasticizer, type | 30, B | 30, B |
| RESULTS | | |
| Prepolymer, % NCO | 12.29 | 12.29 |
| Free Rise Density, lb/ft³ | 1.4 | 1.4 |
| Tack Free Time, sec | 7 | 7 |
| 24 hr Water Absorption, % | 2.14 | 48.75 |

*Not an example of this invention. Plasticizer B is Soygold 1000 soy methyl ester from Ag Processing Inc. Surfactant E is a 65:35 mixture of Tegostab B8870 from Goldschmidt Chemical Corp and DC-198 from Dow Corning. Surfactant F is Tegostab B8443 from Goldschmidt Chemical Corp.

As can be seen from the data in Table 9, the selection of one or more hydrophobicity inducing surfactant as in Example 26 is effective in reducing the amount of water absorption in the cured foam.

1. A method for sealing or insulating a vehicle member or a thermal insulating panel, comprising mixing a polyisocyanate component with a curative component and at least one catalyst for the reaction of a water or a polyol with a polyisocyanate, dispensing the resulting mixture into a cavity of the vehicle member or thermal insulating panel and subjecting the mixture to conditions sufficient to cause it to cure to form a foam having a bulk density of 0.5 to 5 pounds per cubic foot (20-80 kg/m³) that at least partially fills the cavity, wherein
(a) the polyisocyanate component includes a mixture of an isocyanate-terminated prepolymer and at least one alkyl ester of one or more fatty acids, and has an isocyanate content of from about 8 to about 14% by weight and a Brookfield viscosity of no greater than 5000 cps at 25° C.;
(b) the curative component contains isocyanate-reactive materials that have an average functionality of at least about 1.8, wherein the isocyanate-reactive materials include water, at least one polyol, or both water and at least one polyol and
(c) if the curative component does not contain water, the reaction mixture contains at least one other blowing agent.

2. The method of claim 1, wherein the polyisocyanate component further comprises one or more hydrophobicity inducing surfactants.

3. The method of claim 2 wherein the cured foam has a 24-hour water absorption of 20 percent or less.

4. The method of claim 1, wherein the polyisocyanate component has a Brookfield viscosity of no greater than 2000 cps at 25° C.

5. The method of claim 1 wherein the fatty acids are linear monocarboxylic acids that have 12 to 20 carbon atoms.

6. The method of claim 5 wherein the fatty acids are a mixture of the constituent fatty acids of a vegetable oil or animal fat.

7. The method of claim 6 wherein the fatty acids are a mixture of the constituent fatty acids of soy oil.

8. The method of claim 7 wherein component b) includes water.

9. The method of claim 7 wherein component b) includes water and at least one polyol.

10. The method of claim 7 wherein component b) includes at least one catalyst.

11. A polyisocyanate composition comprising (a) an isocyanate terminated reaction product of a polymeric MDI with a difunctional poly(propylene oxide) homopolymer or difunctional copolymer of at least 85% by weight propylene oxide and up to 15% by weight ethylene oxide, which homopolymer or copolymer has a molecular weight of from about 400 to 2200 and (b) at least one alkyl ester of one or more fatty acids, the polyisocyanate composition having an isocyanate content of from about 8 to about 14% by weight and a Brookfield viscosity of no greater than 5000 cps at 25° C.

12. The composition of claim 11 further comprising one or more hydrophobicity inducing surfactants.

13. The composition of claim 11, wherein the polyisocyanate component has a Brookfield viscosity of no greater than 2000 cps at 25° C.

14. The composition of claim 11 wherein the fatty acids are linear monocarboxylic acids that have 12 to 20 carbon atoms.

15. The composition of claim 14 wherein the fatty acids are a mixture of the constituent fatty acids of a vegetable oil or animal fat.

16. The composition of claim 15 wherein the fatty acids are a mixture of the constituent fatty acids of soy oil.

17. The composition of claim 16 wherein the difunctional homopolymer or copolymer has a molecular weight of from 400 to 1500.

18. A foam comprising the reaction product of the composition of claim 11 with a curative that contains isocyanate-reactive materials that have an average functionality of at least about 1.8, wherein the isocyanate-reactive materials include water, at least one polyol, or both water and at least one polyol.
